(19) United States
(12) Patent Application Publication
(10) Pub. No.: US 2010/0131381 A1
(43) Pub. Date: May 27, 2010

(54) Donations Exchange-Computerized Method automate Donations Request, Fulfillment and Tracking

(76) Inventor: David Hassan, (US)

Correspondence Address: DAVID HASSAN, 27645 PRIMROSE LN., MUNDELEIN, IL, 60060, US

(21) Appl. No.: 12/489,110

(22) Filed: Jun. 22, 2009

Related U.S. Application Data
(60) Provisional application No. 61/074,650, filed on Jun. 22, 2008.

(51) Int. Cl. G06Q 40/00; G06Q 30/00; G06Q 20/00; G06Q 10/00

(52) U.S. Cl. 705/26; 705/329

(57) ABSTRACT

A method and apparatus for automating the solicitation process between requesting organizations and donating organization. The web based exchange platform would allow the submission of requests, tracking of submission, approval of submissions, fulfillment of the request, status notification and reporting on the requests for both the requestor and donor. The Exchange automates an old and inefficient paper based process into a paperless platform.

### CROSS-REFERENCE TO RELATED APPLICATIONS

This invention claims priority from Provisional Application No. U.S. 61/074,650

### STATEMENT REGARDING FEDERALLY SPONSORED RESEARCH OR DEVELOPMENT

Not Applicable.

### BACKGROUND OF THE INVENTION

Solicitations for donations are based on paper based manual process. Organizations requesting donations of any type, start by writing a letter and mailing it out to targeted organizations, companies or individuals. They would then rely on individuals related to the soliciting organization to call and follow up on the solicitation letters and to find out the status of the donation from the prospective donors. This is an inefficient process and costly to keep organized and managed for the soliciting organizations.

### BRIEF SUMMARY OF THE INVENTION

To alleviate the problems inherent in the prior art, embodiments of the present invention provide an efficient and effective system and a method for operating a Donation Exchange System. The program relies on a set of standards and integrated processes to facilitate the automating of the Solicitation process.

### DETAILED DESCRIPTION OF THE INVENTION

In one embodiment, a method, an online exchange platform and computer program is provided to participating Soliciting Organizations and Solicited Organization or Individuals. The System would allow the Soliciting Organization to select which organization they would solicit; to update their profile online for each organization they are soliciting; and to submit the solicitation request online.

The Exchange would then send the request electronically to existing Solicited Organizations or Individuals or to new prospects. The recipient would then have the option to accept the request, or to check for available inventory (managed by the exchange); get approvals from with their organization; review the solicitation history and then commit to the request based on the available information. The status of the request would then be passed back to the requesting organization electronically with detail on the participation commitment. The objective of the exchange it to be completely electronic, reducing inefficient paper processes.

In a second embodiment, a donor, can initiate and submit directly to a specific organization thru the Exchange, their participation or donation commitment.

In a third embodiment, the Exchange would allow Recipient Organizations of items to exchange the items with other Organization that might be interested in said items.

In a forth embodiment, the Exchange could generate Certificates per the request of the Certificates issuer to the Soliciting Organization.

In a fifth embodiment, the Exchange would provide statistical information on the exchange member participation and contributions as public announcements. It can also provide detailed tax records on contributions for the participating members.

What is claimed is:

1. A computerized methods for automating handling donation request and fulfillment (exchange), comprising the steps of:
a. Providing a web-based secure server and website configured to handle the donation exchange process;
b. The exchange allows new requesters and new donors to setup new accounts and profiles on the exchange that describes their requirements;
c. The exchange would allow requestors to make online request from a list of potential donors that are already part of the exchange or new donors that the requestor provides;
d. The exchange would transmit the request to each potential donor electronically with a unique tracking coding. The transmission can be done thru various methods including emailing the donors directly;
e. Donors receiving the request would fulfill the request online with their donation information. The exchange would facilitate the automation of any approvals and steps that might be required from the donor organization;
f. The donors can fulfill the request either from an inventory of donation items that they maintain on the exchange, or ad hoc as items become available;
g. A notification will be transmitted to the requestor with the status of the request or donation;
h. The exchange would allow the donors and requestors to retrieve detailed information of the status and history of all donations and requests thru the exchange;
i. The exchange would allow donor organization to host a donation request form for any requesting organization to request a donation. The information would be included into the donation request into the exchange website. The requestor would get an automatic new account on the exchange website for them to access the request and status at any time later in time.

2. The method of claim 1 wherein the exchange website would allow for fulfillment of items with a discounted market value or price that can be purchased thru the exchange.
